(19) United States
(12) Patent Application Publication
(10) Pub. No.: US 2013/0070189 A1
(43) Pub. Date: Mar. 21, 2013

(54) LIQUID CRYSTAL DISPLAY DEVICE

(71) Applicant: Quan Li, Shenzhen (CN)

(72) Inventor: Quan Li, Shenzhen (CN)

(73) Assignee: Shenzhen china Star Optoelectronics Technology Co. Ltd., Shenzhen, Guangdong (CN)

(21) Appl. No.: 13/377,150

(22) PCT Filed: Sep. 29, 2011
(86) PCT No.: PCT/CN11/80388

§ 371 Date: Dec. 9, 2011

(30) Foreign Application Priority Data
Sep. 20, 2011 (CN) 201120353404.0
Sep. 29, 2011 (CN) PCT/CN2011/080388

(51) Int. Cl. G02F 1/1335; G02F 1/1333

(52) U.S. Cl. 349/113; 349/161

(57) ABSTRACT

A liquid crystal display (LCD) device is disclosed. The LCD device comprises an LCD panel, a flexible printed circuit board (FPCB) disposed at a side of the LCD panel, and a chip disposed on the FPCB to drive the LCD panel. The LCD device further comprises a heat dissipating element, and the chip is covered by the heat dissipating element so that heat generated by the chip is dissipated via the heat dissipating element. Thereby, damage to the chip due to an overhigh temperature can be avoided, thus prolonging the service life of the LCD device.

### BACKGROUND

1. Technical Field

The present disclosure relates to the field of liquid crystal displaying, and more particularly, to a liquid crystal display (LCD) device.

2. Description of Related Art

In recent years, LCD devices have found wide application in various fields owing to their advantages such as lightweight, thin, small space occupation and little radiation.

Currently in a kind of LCD device, an LCD panel thereof is provided with a flexible printed circuit board (FPCB). A chip is disposed on the FPCB to drive the LCD panel, which is just the so-called chip on film (COF) technology. However, it is difficult to dissipate the massive heat generated by the chip in a timely manner during operation of the LCD device, so the chip is liable to premature failure. Furthermore, the FPCB has a length of around 8 mm, so the COF cannot be disposed flat together with the LCD panel as in the conventional design but has to be bent downwards to save space. However, if the COF is bent downwards in a natural state, it tends to warp and, consequently, be pierced by the front frame due to friction during the transportation or in use, thus causing a poor displaying quality of images.

### BRIEF SUMMARY

The primary objective of the present disclosure is to provide an LCD which can solve the problem of heat dissipation of a driving chip on an LCD panel.

To achieve this objective, the present disclosure provides an LCD device, which comprises an LCD panel, a flexible printed circuit board (FPCB) disposed at a side of the LCD panel, and a chip disposed on the FPCB to drive the LCD panel. The LCD device further comprises a heat dissipating element, and the chip is covered by the heat dissipating element so that heat generated by the chip is dissipated via the heat dissipating element. The heat dissipating element comprises a thermally conductive buffering material and a first thermally conductive double-sided adhesive tape, and the thermally conductive buffering material is joined to the chip by the first thermally conductive double-sided adhesive tape.

Preferably, the LCD device further comprises a light guide plate and a reflective sheet, wherein an end of the FPCB that is away from the LCD panel is disposed opposite to the light guide plate, and the reflective sheet is disposed between the light guide plate and the thermally conductive buffering material and is attached to the light guide plate.

Preferably, the heat dissipating element further comprises a second thermally conductive double-sided adhesive tape disposed between the reflective sheet and the thermally conductive buffering material, and the reflective sheet is joined to the thermally conductive buffering material by means of the second thermally conductive double-sided adhesive tape.

Preferably, the LCD device further comprises a plastic frame disposed between the light guide plate and the thermally conductive buffering material to support the LCD panel; and the heat dissipating element further comprises a third thermally conductive double-sided adhesive tape disposed between the plastic frame and the thermally conductive buffering material, and the plastic frame is joined to the thermally conductive buffering material by means of the third thermally conductive double-sided adhesive tape.

Preferably, the thermally conductive buffering material is a flexible sheet with thermal conductivity, and at an end of a front side and an opposite end of a back side of the flexible sheet is disposed a fourth thermally conductive double-sided adhesive tape respectively, and the flexible sheet is fixed to FPCBs at two opposite sides of the chip by means of the fourth thermally conductive double-sided adhesive tapes.

Preferably, the first thermally conductive double-sided adhesive tape is disposed at a geometric center position of the flexible sheet.

Preferably, the chip is a source-drive chip or a gate-drive chip.

The present disclosure further provides an LCD device, which comprises an LCD panel, an FPCB disposed at a side of the LCD panel, and a chip disposed on the FPCB to drive the LCD panel. The LCD device further comprises a heat dissipating element, and the chip is covered by the heat dissipating element so that heat generated by the chip is dissipated via the heat dissipating element.

Preferably, the heat dissipating element comprises a thermally conductive buffering material and a first thermally conductive double-sided adhesive tape, and the thermally conductive buffering material is joined to the chip by means of the first thermally conductive double-sided adhesive tape.

Preferably, the LCD device further comprises a light guide plate, wherein an end of the FPCB that is away from the LCD panel is disposed opposite to the light guide plate.

Preferably, the LCD device further comprises a reflective sheet which is disposed between the light guide plate and the thermally conductive buffering material and is attached to the light guide plate.

Preferably, the heat dissipating element further comprises a second thermally conductive double-sided adhesive tape disposed between the reflective sheet and the thermally conductive buffering material, and the reflective sheet is joined to the thermally conductive buffering material by means of the second thermally conductive double-sided adhesive tape.

Preferably, the LCD device further comprises a plastic frame disposed between the light guide plate and the thermally conductive buffering material to support the LCD panel.

Preferably, the heat dissipating element further comprises a third thermally conductive double-sided adhesive tape disposed between the plastic frame and the thermally conductive buffering material, and the plastic frame is joined to the thermally conductive buffering material by means of the third thermally conductive double-sided adhesive tape.

Preferably, the thermally conductive buffering material is a flexible sheet with thermal conductivity, and at an end of a front side and an opposite end of a back side of the flexible sheet is disposed a fourth thermally conductive double-sided adhesive tape respectively, and the flexible sheet is fixed to FPCBs located at two opposite sides of the chip by means of the fourth thermally conductive double-sided adhesive tapes.

Preferably, the first thermally conductive double-sided adhesive tape is disposed at a geometric center position of the flexible sheet.

Preferably, the chip is a source-drive chip or a gate-drive chip.

According to the present disclosure, the chip is covered by a heat dissipating element at the outside so that heat generated by the chip can be dissipated timely. In this way, damage to the chip due to an overhigh temperature can be avoided, thus prolonging the service life of the LCD device.

### BRIEF DESCRIPTION OF THE DRAWINGS

FIG. 1 is a schematic structural view of a first embodiment of an LCD device according to the present disclosure;

FIG. 2 is an enlarged view of a juncture C where an FPCB joins with an LCD panel in the LCD device of FIG. 1;

FIG. 3 is a schematic structural view of a second embodiment of the LCD device according to the present disclosure;

FIG. 4 is a schematic structural view of a thermally conductive buffering material in a third embodiment of the LCD device according to the present disclosure.

Hereinafter, implementations, functional features and advantages of the present disclosure will be further described with reference to embodiments thereof and the attached drawings.

### DETAILED DESCRIPTION

It shall be understood that, the embodiments described herein are only intended to illustrate but not to limit the present disclosure.

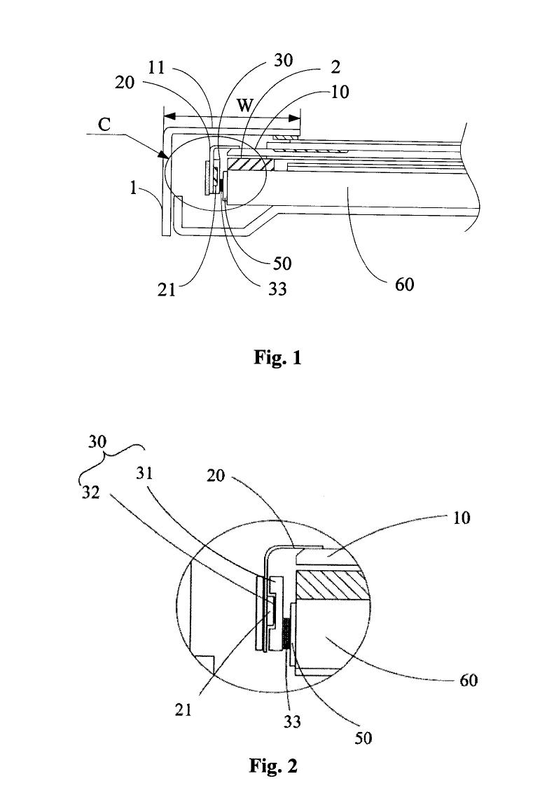

Referring to FIG. 1 and FIG. 2, FIG. 1 is a schematic structural view of a first embodiment of an LCD device according to the present disclosure, and FIG. 2 is an enlarged view of a juncture C where an FPCB joins with an LCD panel in the LCD device of FIG. 1.

In this embodiment, the LCD device comprises an LCD panel 10, an FPCB 20 disposed at a side of the LCD panel 10, and a chip 21 disposed on the FPCB 20 for driving the LCD panel 10. The LCD device further comprises a heat dissipating element 30 adapted to cover the chip 21 so that heat generated by the chip 21 can be dissipated via the heat dissipating element 30. In this way, damage to the chip due to an overhigh temperature can be avoided to prolong the service life of the LCD device. Furthermore, the chip 21 is a source-drive chip or a gate-drive chip in this embodiment.

In an embodiment, the heat dissipating element 30 comprises a thermally conductive buffering material 31 and a first thermally conductive double-sided adhesive tape 32. The thermally conductive buffering material 31 is used to dissipate the heat from the chip 21, and is joined with the chip 21 by means of the first thermally conductive double-sided adhesive tape 32. In this embodiment, the thermally conductive buffering material 31 is thermally conductive foam and may be formed into a plate shape. At a middle portion of a surface of the thermally conductive buffering material 31 is disposed a recess for receiving the chip 21 so as to cover the chip 21. A bottom surface of the recess may be adhered to a surface of the chip 21 by means of the first thermally conductive double-sided adhesive tape 32. As the thermally conductive buffering material 31 and the chip 21 are joined together by means of the first thermally conductive double-sided adhesive tape 32, heat generated by the chip 21 can be transferred through the first thermally conductive double-sided adhesive tape 32 to the thermally conductive buffering material 31 and be further dissipated outwards from the thermally conductive buffering material 31.

In this embodiment, the LCD device further comprises a light guide plate 60, and an end of the FPCB 20 that is away from the LCD panel 10 is disposed opposite to the light guide plate 60. Specifically, the light guide plate 60 is disposed corresponding to the LCD panel 10. A buffering plate 2 is disposed between the light guide plate 60 and the LCD panel 10 to support the LCD panel 10 at an end of the light guide plate 60 and the LCD panel 10. The FPCB 20 is bent from the LCD panel 10 towards the light guide plate 60 in such a way that the thermally conductive buffering material 31 is opposite to the light guide plate 60. A reflective sheet 50 is attached to the light guide 60 between the light guide plate 60 and the thermally conductive buffering material 31. A width W of a side frame 11 which is on the front frame 1 is significantly reduced by bending the FPCB 20 towards the light guide plate 60 for resulting in a narrow side-frame design of the LCD device, wherein the front frame 1 is used to receive the FPCB 20 in the LCD device with the side frame 11 facing the viewers. The FPCB 20 that is bent may be joined with the light guide plate 60 or other objects in various ways, for example, by use of glue or a double-sided adhesive tape, so as to fix the FPCB 20. This can prevent the FPCB from warping and consequently being scratched or pierced by the iron frame or other objects, and also facilitate an even narrower side-frame design. Preferably in this embodiment, a thermally conductive double-sided adhesive tape is disposed between the FPCB 20 and the light guide plate 60 to fix the FPCB 20. As shown in FIG. 2, in addition to the first thermally conductive double-sided adhesive tape 32, the heat dissipating element 30 further comprises a second thermally conductive double-sided adhesive tape 33 disposed between the reflective sheet 50 and the thermally conductive buffering material 31. The reflective sheet 50 and the thermally conductive buffering material 31 are joined with each other by means of the second thermally conductive double-sided adhesive tape 33. By disposing the second thermally conductive double-sided adhesive tape 33 in this embodiment, the FPCB 20 can be fixed together with the reflective sheet 50; and this can prevent them from warping and consequently being scratched or pierced by the iron frame or other objects, and also facilitate an even narrower side-frame design.

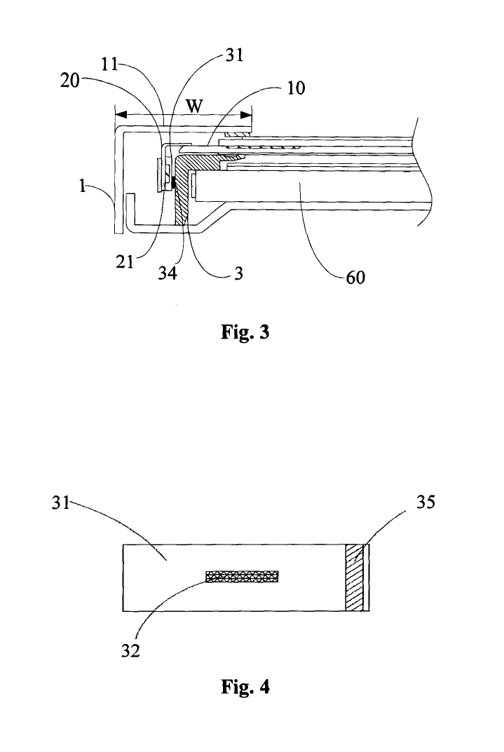

Referring to FIG. 3, there is shown a schematic structural view of a second embodiment of the LCD device according to the present disclosure. This embodiment differs from the first embodiment in that, the LCD device comprises a plastic frame 3 in place of the buffering plate 2 of the first embodiment. The plastic frame 3 is disposed between the light guide plate 60 and the thermally conductive buffering material 31 to support the LCD panel 10. In addition to the first thermally conductive double-sided adhesive tape 32, the heat dissipating element 30 further comprises a third thermally conductive double-sided adhesive tape 34 disposed between the plastic frame 3 and the thermally conductive buffering material 31. The plastic frame 3 and the thermally conductive material 31 are joined together by means of the third thermally conductive double-sided adhesive tape 34. Similar to the second thermally conductive double-sided adhesive tape 33, the third thermally conductive double-sided adhesive tape 34 also functions to fix the FPCB 20 and transfer the heat, so it may also be replaced by the second thermally conductive double-sided adhesive tape 33.

Referring to FIG. 4, there is shown a schematic structural view of a thermally conductive buffering material 31 in a third embodiment of the present disclosure.

The third embodiment differs from the first embodiment and the second embodiment in that, the thermally conductive buffering material 31 is a flexible sheet with thermal conductivity such as a piece of thermoplastic elastomer. On an end of a front side and an opposite end of a back side of the flexible sheet is disposed a fourth thermally conductive double-sided adhesive tape 35 respectively (only one side is shown). One of the fourth thermally conductive double-sided adhesive tape 35 joins with an FPCB 20 at one side of the chip, while the other fourth thermally conductive double-sided adhesive tape 35 joins with an FPCB 20 at the opposite side of the chip. Specifically, when the flexible sheet with thermal conductivity is to be disposed, the first thermally conductive double-sided adhesive tape 32 is disposed at a geometric centre position of the flexible sheet and then adheres to the chip 21; then the flexible sheet with thermal conductivity is bent at both sides to form a space for receiving the chip 21; and finally, the thermally conductive buffering material 31 is joined at both ends to the FPCB 20 by means of the fourth thermally conductive double-sided adhesive tape to cover the chip 21.

According to the embodiments of the LCD according to the present disclosure, the chip 21 on the FPCB 20 is covered by a heat dissipating element 30 so that heat generated by the chip 21 can be dissipated timely. In this way, damage to the chip 21 due to an overhigh temperature can be avoided, thus prolonging the service life of the LCD device. Moreover, because the FPCB 20 is fixed in the present disclosure, a narrow side-frame design can be achieved, and warping of the FPCB 20 can be avoided so that it will not be scratched or pierced by the iron frame or other objects.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A liquid crystal display (LCD) device, comprising an LCD panel, a flexible printed circuit board (FPCB) disposed at a side of the LCD panel, and a chip disposed on the FPCB to drive the LCD panel, wherein the LCD device further comprises a heat dissipating element, the chip is covered by the heat dissipating element so that heat generated by the chip is dissipated via the heat dissipating element, the heat dissipating element comprises a thermally conductive buffering material and a first thermally conductive double-sided adhesive tape, and the thermally conductive buffering material is joined to the chip by the first thermally conductive double-sided adhesive tape.

2. The LCD device of claim 1, further comprising a light guide plate and a reflective sheet, wherein an end of the FPCB that is away from the LCD panel is disposed opposite to the light guide plate, and the reflective sheet is disposed between the light guide plate and the thermally conductive buffering material and is attached to the light guide plate.

3. The LCD device of claim 2, wherein the heat dissipating element further comprises a second thermally conductive double-sided adhesive tape disposed between the reflective sheet and the thermally conductive buffering material, and the reflective sheet is joined to the thermally conductive buffering material by means of the second thermally conductive double-sided adhesive tape.

4. The LCD device of claim 2, further comprising a plastic frame disposed between the light guide plate and the thermally conductive buffering material to support the LCD panel, wherein the heat dissipating element further comprises a third thermally conductive double-sided adhesive tape disposed between the plastic frame and the thermally conductive buffering material, and the plastic frame is joined to the thermally conductive buffering material by means of the third thermally conductive double-sided adhesive tape.

5. The LCD device of claim 1, wherein the thermally conductive buffering material is a flexible sheet with thermal conductivity, and at an end of a front side and an opposite end of a back side of the flexible sheet is disposed a fourth thermally conductive double-sided adhesive tape respectively, and the flexible sheet is fixed to FPCBs at two opposite sides of the chip by means of the fourth thermally conductive double-sided adhesive tapes.

6. The LCD device of claim 5, wherein the first thermally conductive double-sided adhesive tape is disposed at a geometric center position of the flexible sheet.

7. The LCD device of claim 1, wherein the chip is a source-drive chip or a gate-drive chip.

8. An LCD device, comprising an LCD panel, an FPCB disposed at a side of the LCD panel, and a chip disposed on the FPCB to drive the LCD panel, wherein the LCD device further comprises a heat dissipating element, and the chip is covered by the heat dissipating element so that heat generated by the chip is dissipated via the heat dissipating element.

9. The LCD device of claim 8, wherein the heat dissipating element comprises a thermally conductive buffering material and a first thermally conductive double-sided adhesive tape, and the thermally conductive buffering material is joined to the chip by means of the first thermally conductive double-sided adhesive tape.

10. The LCD device of claim 9, further comprising a light guide plate, wherein an end of the FPCB that is away from the LCD panel is disposed opposite to the light guide plate.

11. The LCD device of claim 10, further comprising a reflective sheet which is disposed between the light guide plate and the thermally conductive buffering material and is attached to the light guide plate.

12. The LCD device of claim 11, wherein the heat dissipating element further comprises a second thermally conductive double-sided adhesive tape disposed between the reflective sheet and the thermally conductive buffering material, and the reflective sheet is joined to the thermally conductive buffering material by means of the second thermally conductive double-sided adhesive tape.

13. The LCD device of claim 11, further comprising a plastic frame disposed between the light guide plate and the thermally conductive buffering material to support the LCD panel.

14. The LCD device of claim 13, wherein the heat dissipating element further comprises a third thermally conductive double-sided adhesive tape disposed between the plastic frame and the thermally conductive buffering material, and the plastic frame is joined to the thermally conductive buffering material by means of the third thermally conductive double-sided adhesive tape.

15. The LCD device of claim 9, wherein the thermally conductive buffering material is a flexible sheet with thermal conductivity, and at an end of a front side and an opposite end of a back side of the flexible sheet is disposed a fourth thermally conductive double-sided adhesive tape respectively, and the flexible sheet is fixed to FPCBs located at two opposite sides of the chip by means of the fourth thermally conductive double-sided adhesive tapes.

16. The LCD device of claim 15, wherein the first thermally conductive double-sided adhesive tape is disposed at a geometric center position of the flexible sheet.

17. The LCD device of claim 8, wherein the chip is a source-drive chip or a gate-drive chip.
